(19) United States
(12) Patent Application Publication
(10) Pub. No.: US 2026/0143036 A1
(43) Pub. Date: May 21, 2026

(54) FLOW LINE ANALYSIS PRETREATMENT DEVICE, METHOD, AND PROGRAM

(71) Applicant: NTT, Inc., Tokyo (JP)

(72) Inventors: Miyuki IMADA, Tokyo (JP); Hisashi KURASAWA, Tokyo (JP); Masakuni ISHII, Tokyo (JP); Yoshifumi FUKUMOTO, Tokyo (JP); Kensuke FUKUSHIMA, Tokyo (JP); Tetsuya SHIODA, Tokyo (JP); Susumu YAMAMOTO, Tokyo (JP)

(73) Assignee: NTT, Inc., Tokyo (JP)

(21) Appl. No.: 19/120,327

(22) PCT Filed: Oct. 12, 2022
(86) PCT No.: PCT/JP2022/038115

§ 371 Date: Apr. 11, 2025

(51) Int. Cl. H04L 67/1396; H04L 67/025

(52) U.S. Cl. CPC H04L 67/1396; H04L 67/025

(57) ABSTRACT

An extraction unit (22) extracts a pattern that is a set of frequent actions or states from a plurality of pieces of flow line information indicating transitions of actions or states for each user, an unnecessary pattern exclusion unit (23) excludes a pattern in which the last action or state of the pattern does not correspond to a purpose of analysis among the extracted patterns, and a judgement unit (24) judges a pattern in which an appearance frequency in a flow line DB (20) is equal to or more than a threshold value for each of the extracted patterns as the analysis target pattern.

### TECHNICAL FIELD

The disclosed technique relates to a flow line analysis preprocessing device, a flow line analysis preprocessing method, and a flow line analysis preprocessing program.

### BACKGROUND ART

In recent years, many companies have promoted a shift from a store-centric service to a Web procedure in the wake of the Corona disaster. The number of stores in good locations in front of train stations will have to be reduced, in spite of the high rent, since there is a concern about health of employee, in addition to income loss due to sharp decrease of the number of users at the Corona disaster.

Although a company with compact service contents can smoothly shift to the Web procedure, a company providing a wide variety of services often does not originally construct a system on an assumption of the Web procedure, and a large cost is required for improvement. Although a method for temporarily interrupting a service provided on the Web may be considered, many services to be provided are not allowed to interrupt the service provision because of overall replacement of the Web service.

In order to allow the company providing such a wide variety of services to efficiently shift to the Web procedure without interrupting the Web service, it is important to find a portion where the Web procedure cannot be completed, that is, the portion leading to the withdrawal of the Web procedure. For example, it is a Web page which is difficult for a user to understand or a transition portion between Web pages.

In an analysis of a flow line of the Web page, data preprocessing is one of important processes. When the preprocessing is neglected, an analysis result becomes unreliable, and it is necessary to make data close to a real world as much as possible.

As a conventional technique related to the flow line analysis, as a result of analysis, there are a technique for calculating a withdrawal percentage (for example, NPL 1) and a technique for grasping an individual flow line leading to the withdrawal (for example, NPL 2 and NPL 3). The technique described in NPL 2 can grasp attributes such as gender and age, and a flow line such as an action that has reached conversion (contract establishment or the like) for each user. The technique described in NPL 3 embeds a tag for grasping the action of the user in a program, performs the analysis of Web access associated with the action of the user, and collect information on taste and sense of value of the user.

### CITATION LIST

### Non Patent Literature

[NPL 1] “google analytics action flow”, [online], [retrieved on Sep. 4, 2022], Internet <URL: https://support.google.com/analytics/answer/2785577?h1=ja#zippy=%2C%E3%81893%E3881%AEE88A8%98%E4% BA%8B&E3%818AE%E5886885%E5% AE&B9>
[NPL 2] “User Insight”, [online], [retrieved on Sep. 4, 2022], Internet <URL: https://ui.userlocal.jp/>
[NPL 3] “Juicer”, [online], [retrieved on Sep. 4, 2022], Internet <URL: https://juicer.cc/>

### SUMMARY OF INVENTION

### Technical Problem

For example, when a contract procedure for the purpose is performed on the Web, it is not necessary to browse all the related pages, and visit order to each page do not necessarily have to be as assumed. Due to such an arbitrariness of a flow line, flow line information with a large number of patterns is acquired, and it is important to select only the flow line information suitable for the purpose in order to analyze the flow line. For example, as mentioned above, in order to grasp at which page the user withdraws in the Web procedure, the flow line information leading to the withdrawal is selected among the flow line information of each user.

However, in the above-mentioned conventional technique, the preprocessing cannot be performed, such as extracting only the flow line information of the user who has withdrawn the Web procedure in spite of originally intending to perform the Web procedure.

The disclosed technique has been made in view of the above-described point, and an object thereof is to extract the flow line information for analyzing a withdrawal cause of the procedure from a large amount of flow line information.

### Solution to Problem

A first aspect of the present disclosure relates to a flow line analysis preprocessing device including an extraction unit that extracts a pattern that is a set of frequent actions or states from a plurality of pieces of flow line information indicating transitions of actions or states for each user, a judgement unit that judges a pattern having an appearance frequency in the plurality of pieces of flow line information equal to or more than a threshold value for each of the patterns extracted by the extraction unit as an analysis target pattern, and an unnecessary pattern exclusion unit that excludes a pattern in which the last action or state of the pattern does not correspond to a purpose of analysis from the analysis target pattern.

A second aspect of the present disclosure is a flow line analysis preprocessing method, in which an extraction unit extracts a pattern that is a set of frequent actions or states from a plurality of pieces of flow line information indicating transitions of actions or states for each user, a judgement unit judges a pattern having an appearance frequency in the plurality of pieces of flow line information equal to or more than a threshold value for each of the patterns extracted by the extraction unit as an analysis target pattern, and an unnecessary pattern exclusion unit excludes a pattern in which the last action or state of the pattern does not correspond to a purpose of analysis from the analysis target pattern.

A third aspect of the present disclosure is a flow line analysis preprocessing program causing a computer to function as each unit configuring the above-described flow line analysis preprocessing device.

### Advantageous Effects of Invention

According to the disclosed technique, the flow line information for analyzing the withdrawal cause of the procedure can be extracted from a large amount of flow line information.

### BRIEF DESCRIPTION OF DRAWINGS

FIG. 1 is an image diagram of a flow line of a Web page considered by a designer and a flow line of a user.

FIG. 2 is a diagram for explaining a pattern of an analysis target.

FIG. 3 is a block diagram showing a hardware configuration of a flow line analysis preprocessing device.

FIG. 4 is a block diagram showing an example of a functional configuration of the flow line analysis preprocessing device according to a first embodiment.

FIG. 5 is a flowchart showing a flow of flow line analysis preprocessing according to the first embodiment and a second embodiment.

FIG. 6 is a block diagram showing an example of a functional configuration of a flow line analysis preprocessing device according to the second embodiment.

FIG. 7 is a diagram for explaining a decision of a threshold value of a hop count.

FIG. 8 is a flowchart showing a flow of unnecessary flow line exclusion processing.

FIG. 9 is a block diagram showing an example of a functional configuration of a flow line analysis preprocessing device according to a third embodiment.

FIG. 10 is a diagram for explaining a concept of the third embodiment.

FIG. 11 is a flowchart showing a flow of the flow line analysis preprocessing according to the third embodiment.

FIG. 12 is a flowchart showing a flow of division processing.

FIG. 13 is a flowchart showing a flow of specific pattern extraction processing.

### DESCRIPTION OF EMBODIMENTS

Hereinafter, one example of embodiments of the disclosed technique will be described with reference to the drawings. Note that, in each drawing, the same or equivalent constituent components and portions are denoted by the same reference numerals. In addition, dimensional ratios in the drawings are exaggerated for convenience of description and may differ from actual ratios.

### <Outline of Embodiment>

Prior to describing details of each embodiment, problems and concept of the present disclosure will be described as an outline common to each embodiment. Note that, in each of the following embodiments, description will be given of a case where flow line information indicating a transition of a Web page is an analysis target as a transition of an action or a state for each user.

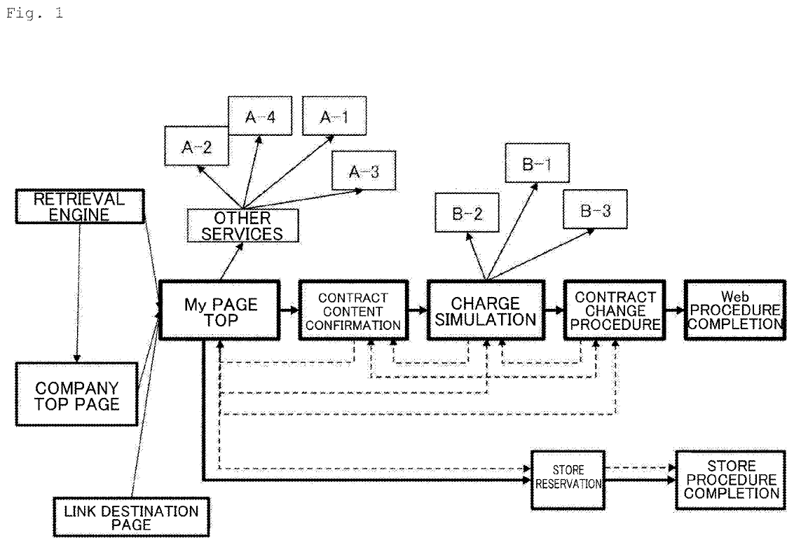

FIG. 1 shows an image of the flow line of the Web page considered by the designer and the flow line of the user. In FIG. 1, each Web page of “My page top”, “contract content confirmation”, “charge simulation”, and “contract change procedure”, which is an example of a Web procedure system independently created by four different organizations, is shown. In FIG. 1, a solid line arrow is the flow line considered by the designer. In addition, each Web page created in each organization is configured to transit from a table of contents page to another page in the organization in accordance with processing respectively, return to the table of contents page when the processing related to the procedure in the organization terminates, and urge to proceed to the next procedure.

In the case of providing various services and procedures on the Web to the user, a company operating the Web page usually performs route design (flow line design) on the Web so that the user transits the Web page on the optimum route (solid line arrow in FIG. 1). The flow line design includes a Web page transition design for moving from one Web page to another Web page, a layout design of a user's perspective in the Web page, and the like.

When the user transits the Web page as the designer considers, that is fine. But there is a case in which the user who is familiar with the Web procedure or the user who is not familiar with the Web procedure may transit the Web page different from the designer's intention. For example, as shown by the broken line arrow in FIG. 1, when arbitrariness of the transition between the Web pages, the user does not always make the transition as considered by the designer. This is not necessarily a problem of only user skill alone, such as when the user interface is difficult to understand.

In order to grasp where there is a problem in the flow line, it is important to trace the flow line that is a route where the user has actually transited on the Web page. The flow line grasping is to grasp and analyze the movement of the user on the Web, becomes a clue to estimate what intention and psychological state the user has moved, and leads to problem finding in increasing a conversion percentage.

The design of the Web page itself may be improved if there is a problem in view. However, since the flow line of the user has various routes for each user as shown by the broken line arrows in FIG. 1, it is difficult to grasp where there is a problem in the flow line. In addition, when the Web design is created, operated, managed, or the like in the organization unit, the Web design is formed into a silo for each organization. When the Web procedure is viewed as a series of flows, the user may feel that the procedure is complicated and give up the Web procedure because the Web procedure is returned to the table of contents page of the top many times or enters a target page from an entrance different from the top.

In addition, a psychological hurdle of the user is low with respect to a use of the Web page such as a charge simulation for determining an appropriate charge and commodity retrieval created by the company in consideration of convenience of the user. On the other hand, it is highly psychological hurdle for the user to perform procedures such as a contract change and a new contract on the Web. Further, every time a contract is made on the Web, there is a confirmation page such as a large number of rules with small characters, and there is a case where next progress is not made unless approval is made. There are users who feel pain at a constant rate in response to repetition of such approval processing many times. These users give up the procedure on the Web, go to a real store, and select to make a contract while receiving an explanation from a clerk, so that a shift to the Web procedure cannot be easily realized.

The user who cannot complete the intended procedure or the like and withdraws the Web procedure moves back and force between various Web pages, as a result. Therefore, the arbitrariness of the flow line of the user becomes high, and it becomes difficult to grasp which page the user tends to stumble, and the like.

Further, in the case of analyzing the flow line of the user with high arbitrariness, it is difficult to distinguish whether the user does not originally intend to perform the Web procedure and directly makes the store reservation or starts a series of actions for the Web procedure and withdraws on the way to make the store reservation. In addition, the user who wants to confirm contract contents takes actions such as top page of the company→My page top→contract contents confirmation→withdrawal by using a retrieval engine or the like, for example. Further, the user who originally wants to deal with manned support takes actions such as top page of the company→My page top→store reservation→withdrawal by using the retrieval engine or the like. A method of removing the above-described flow line information of the user by tracing the user's action using the above-mentioned NPL 2 and NPL 3, and the like can be considered. However, since the flow line information of the user can be mechanically collected from log data, the amount of the flow line information becomes huge, and it is not practical to use all of them as analysis target.

Therefore, as preprocessing for analyzing the withdrawal cause of the Web procedure, a technique for mechanically classifying the flow line information of the user who does not originally intend to perform the Web procedure and the flow line information of the user who intends to perform the Web procedure but withdraws due to some causes.

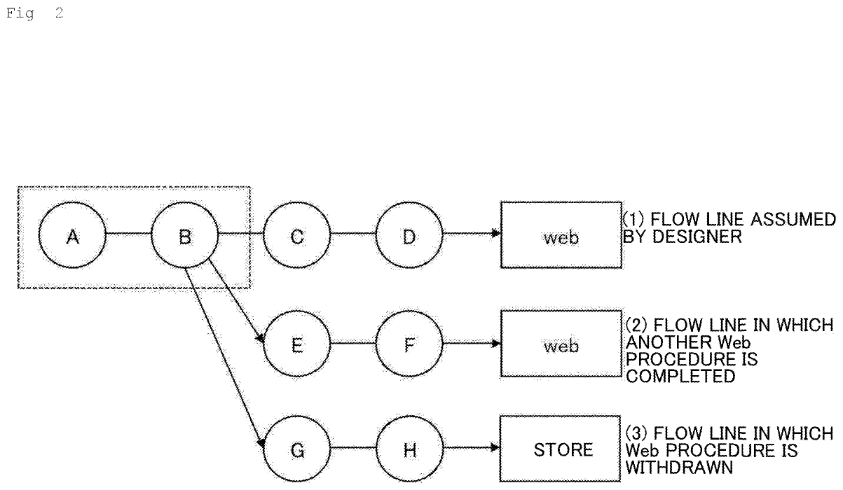

FIG. 2 shows a concept of the present disclosure. In FIG. 2, A, B, . . . , H shows the Web page, respectively. In order to complete the predetermined Web procedure, it is assumed that the flow line along the flow line assumed by the designer is a flow line (1) A→B→C→D. The user who has performed the procedure on the flow line (1) completes the Web procedure without any problem. The flow line (2) A→B→E→F is common to the flow line (1) in A→B, but is a flow line of a user who has performed a procedure different from that of the flow line (1). The flow line (3) is a flow line of a user who intends to perform the same Web procedure as the flow line (1) at first, moves to A→B, but loses the way, transits on A→B→G→H, and withdraws.

In each embodiment below, it is a purpose to extract the flow line information for analyzing the withdrawal cause of the Web procedure. Therefore, the flow line (1) completing the Web procedure and the flow line (2) performing another procedure are excluded because they are flow lines unrelated to the analysis of the withdrawal cause, and the flow line (3) is extracted. Hereinafter, each embodiment will be described in detail.

### First Embodiment

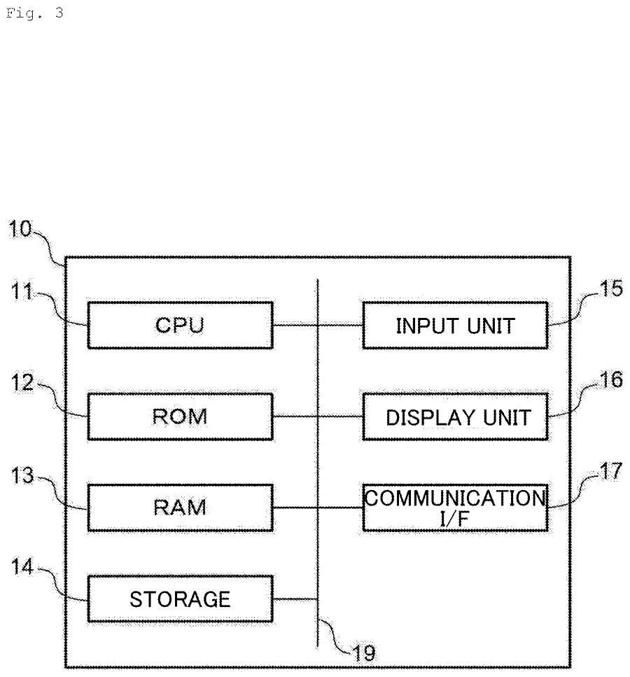

FIG. 3 is a block diagram showing a hardware configuration of a flow line analysis preprocessing device. As shown in FIG. 3, the flow line analysis preprocessing device 10 has a CPU (Central Processing Unit) 11, a ROM (Read Only Memory) 12, a RAM (Random Access Memory) 13, a storage 14, an input unit 15, a display unit 16, and a communication I/F (Interface) 17. Each constituent component is communicatively connected to each other via a bus 19.

The CPU 11 is a central processing unit and executes various programs or controls each unit. That is, the CPU 11 reads a program from the ROM 12 or the storage 14 and executes the program using the RAM 13 as a work region. The CPU 11 performs control of above-described each constituent component and various types of arithmetic processing in accordance with the program stored in the ROM 12 or the storage 14. In the present embodiment, the ROM 12 or the storage 14 stores a flow line analysis preprocessing program for executing flow line analysis preprocessing to be described later.

The ROM 12 stores various programs and various types of data. The RAM 13 temporarily stores the program or data as the work region. The storage 14 is configured by a storage device such as an HDD (Hard Disk Drive) or an SSD (Solid State Drive) and stores various programs including an operating system and various types of data.

The input unit 15 includes a pointing device such as a mouse and a keyboard and is used to perform various inputs. The display unit 16 is, for example, a liquid crystal display and displays various types of information. The display unit 16 may adopt a touch panel scheme and function as the input unit 15. The communication I/F 17 is an interface for communication with other equipment. For such communication, for example, a wired communication standard such as Ethernet (registered trademark) or FDDI, or a wireless communication standard such as 4G, 5G, or Wi-Fi (registered trademark) is used.

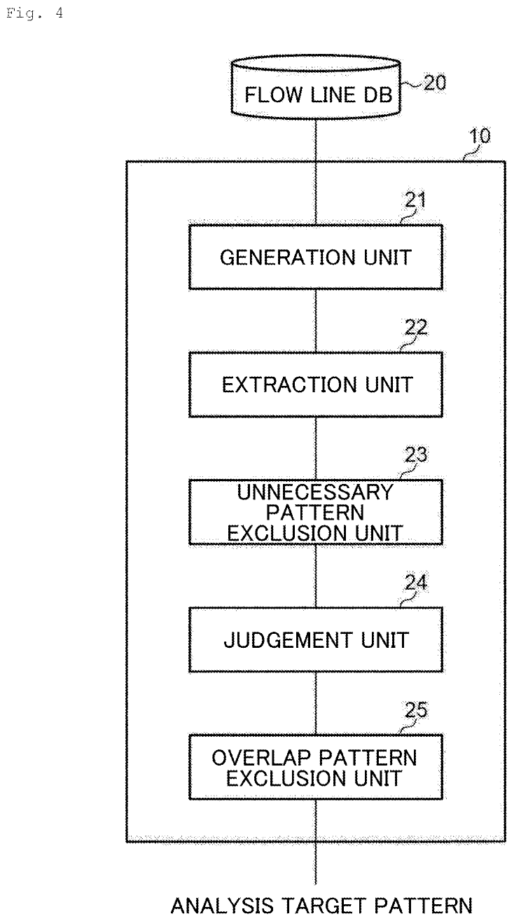

Next, a functional configuration of the flow line analysis preprocessing device 10 will be described. FIG. 4 is a block diagram showing an example of the functional configuration of the flow line analysis preprocessing device 10. As shown in FIG. 4, the flow line analysis preprocessing device 10 has a generation unit 21, an extraction unit 22, an unnecessary pattern exclusion unit 23, a judgement unit 24, and an overlap pattern exclusion unit 25 as the functional configuration. Each functional configuration is realized by causing the CPU 11 to read the flow line analysis preprocessing program stored in the ROM 12 or the storage 14, deploy it into the RAM 13, and execute it.

The generation unit 21 acquires a plurality of pieces of flow line information stored in a flow line DB (database) 20. The flow line information is information indicating the transition of the Web page for each user, and for example, a pair of identification information (for example, URL) of the Web page visited by the user and time point information when the Web page is visited is arranged in time series. The generation unit 21 generates a list in which labels representing the action of the user, for example, labels representing the Web pages visited by the user, are arranged in an order of time point of visiting, from the acquired flow line information for each user as series data for each user. The generation unit 21 delivers the generated series data for each user to the extraction unit 22.

The extraction unit 22 extracts a pattern which is a set of frequent Web pages from the series data for each user delivered from the generation unit 21. The extraction unit 22 extracts the pattern from the series data for each user by using an extraction algorithm of frequent pattern mining such as PrefixSpan, for example. The extraction unit 22 delivers the extracted pattern to the unnecessary pattern exclusion unit 23.

The unnecessary pattern exclusion unit 23 excludes a pattern which does not correspond to a purpose of analysis from the patterns delivered from the extraction unit 22. In the present embodiment, since it is a purpose to analyze the withdrawal cause of the Web procedure, for example, the unnecessary pattern exclusion unit 23 excludes patterns (corresponding to (1) and (2) in FIG. 2) in which the last Web page of the pattern indicates the Web procedure completion. The unnecessary pattern exclusion unit 23 delivers the remaining patterns without exclusion to the judgement unit 24.

The judgement unit 24 judges whether or not appearance frequency in the flow line DB 20 is equal to or more than a predetermined threshold value minsup for each pattern delivered from the unnecessary pattern exclusion unit 23. The judgement unit 24 delivers the pattern judged that the appearance frequency is equal to or more than the threshold value minsup to the overlap pattern exclusion unit 25.

Since the information represented by each pattern has overlap, it is not always necessary to set all the patterns to the analysis target. Therefore, the overlap pattern exclusion unit 25 excludes one of two patterns partially coinciding with each other from the analysis target among the patterns delivered from the judgement unit 24. Specifically, when a first pattern coincides with a part of a second pattern and a difference between the appearance frequency of the first pattern and the appearance frequency of the second pattern in the flow line DB 20 is equal to or less than a predetermined value, the overlap pattern exclusion unit 25 excludes the first pattern. By excluding the overlap pattern in this manner, the analysis target pattern to be outputted can be presented in a simpler manner.

The patterns to be excluded by the overlap pattern exclusion unit 25 will be described more specifically. It is assumed that two patterns in which one is the other partial pattern are extracted as in an example below. Note that, in the present embodiment, a pattern p expressed as Xᵢ₁→Xᵢ₂→ . . . →Xᵢₘ (1≤i1<i2< . . . <im≤n) is called a partial pattern of the pattern q for the pattern q: X₁→X₂→ . . . →Xₙ.

<Example> Pattern p is a partial pattern of Pattern q
Pattern p: simulation TOP→store reservation
Pattern q: simulation TOP→simulation result→store reservation

In this case, if many of the users who have traced the pattern p trace the pattern q, even if the pattern p is excluded, it is considered that a pattern which frequently appears as the action of the user can be grasped from only the pattern q. Therefore, the overlap pattern exclusion unit 25 excludes the pattern p, when there is another pattern q that has the partial pattern of the pattern p and whose appearance frequency does not largely change from the pattern p for each pattern p.

More specifically, a set of patterns having the pattern p as the partial pattern and a length of n or more among all patterns delivered from the judgement unit 24 is set to L (p, n). Also, the length of the pattern p is set to be len (p), the maximum value of len (p) is set to be l_max, and the number of patterns p is set to be freq (p).

In this case, the overlap pattern exclusion unit 25 performs the following processing for k=l_max−1, . . . , 2. The overlap pattern exclusion unit 25 calculates a maximum value f_max of the number of patterns q freq (q) included in L (p, len (p)+1) for each pattern p of length k. Then, the overlap pattern exclusion unit 25 excludes the pattern p in the case where f_max>freq (p)×threshold. Note that, as the threshold, for example, a value of 0.8 or the like is set, so that the change in the number of patterns after the exclusion by the overlap pattern exclusion unit 25 becomes substantially flat.

The overlap pattern exclusion unit 25 outputs the pattern after the overlap exclusion as the analysis target pattern or stores it in an analysis target pattern DB (not shown).

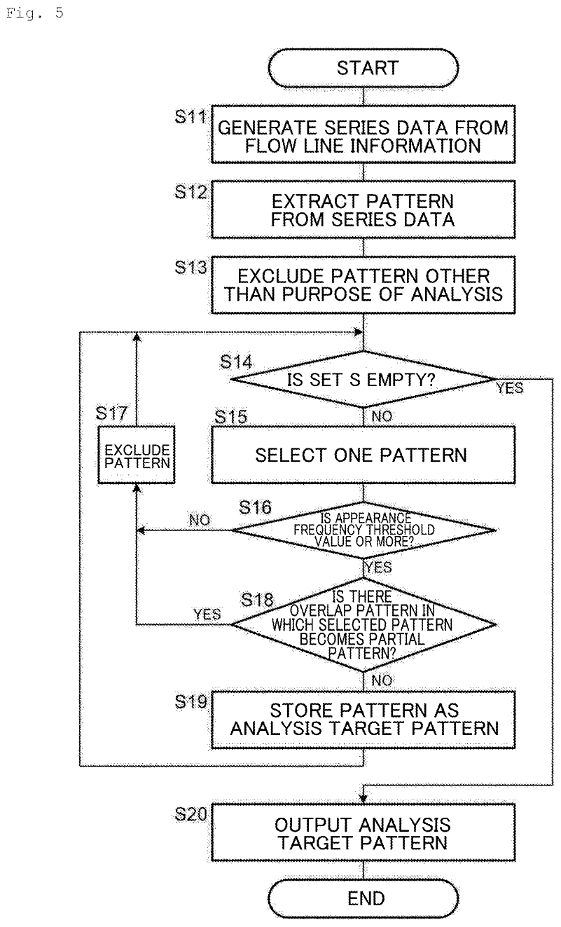

Next, operations of the flow line analysis preprocessing device 10 will be described. FIG. 5 is a flowchart showing a flow of the flow line analysis preprocessing performed by the flow line analysis preprocessing device 10. The flow line analysis preprocessing is performed by causing the CPU 11 to read the flow line analysis preprocessing program from the ROM 12 or the storage 14, deploy it into the RAM 13, and execute it. Note that the flow line analysis preprocessing is one example of the flow line analysis preprocessing method of the present disclosure.

In step S11, the CPU 11 acquires a plurality of pieces of flow line information stored in the flow line DB 20 and generates the list in which labels indicating the action of the user are arranged in the order of time point from the plurality of pieces of acquired flow line information as series data for each user as the extraction unit 22.

Next, in step S12, the CPU 11 extracts the patterns which is the set of frequent Web pages from the series data for each user as the extraction unit 22. Next, in step S13, the CPU 11 excludes the patterns which do not correspond to the purpose of analysis from the extracted patterns as the unnecessary pattern exclusion unit 23.

Next, in step S14, the CPU 11 puts the remaining patterns without being excluded in above-described step S13 into a set S as the judgement unit 24. Then, the CPU 11 judges whether or not the set S is empty as the judgement unit 24. When the set S is not empty, the processing is shifted to step S15, and the CPU 11 selects one pattern from the set S as the judgement unit 24.

Next, in step S16, the CPU 11 judges whether or not the appearance frequency in the flow line DB 20 is equal to or more than the predetermined threshold value minsup for the selected patterns as the judgement unit 24. When the appearance frequency is equal to or more than the threshold value minsup, the processing is shifted to step S18. On the other hand, when the appearance frequency is less than the threshold value minsup, the processing is shifted to step S17, and the CPU 11 excludes the selected patterns from the set S as the judgement unit 24, and the processing is returned to step S14.

In step S18, the CPU 11 judges whether or not there is an overlap pattern in which the selected pattern becomes a partial pattern in a set T for storing the analysis target patterns to be described later as the overlap pattern exclusion unit 25. The overlap pattern is a pattern in which the appearance frequency in the flow line DB 20 does not largely change from an appearance frequency of the selected pattern. When the overlap pattern is present, the processing is shifted to step S17, and the CPU 11 excludes the selected pattern from the set S as the overlap pattern exclusion unit 25, and the processing is returned to step S14. On the other hand, when the overlap pattern is not present, the processing is shifted to step S19, and the CPU 11 stores the selected pattern in the set T as the analysis target pattern as the overlap pattern exclusion unit 25, and the processing is returned to step S14.

When it is judged that the set S is empty in step S14, in step S20, the CPU 11 outputs the analysis target pattern stored in the set T as the overlap pattern exclusion unit 25, and the flow line analysis preprocessing is terminated.

As described above, the flow line analysis preprocessing device according to the first embodiment extracts the pattern which is the set of frequent Web pages from the plurality of pieces of flow line information indicating transitions of Web pages for each user. Then, the flow line analysis preprocessing device judges the pattern whose appearance frequency in the plurality of pieces of flow line information is equal to or more than the threshold value as the analysis target for each of the extracted patterns. Further, the flow line analysis preprocessing device excludes the pattern in which the last Web page of the pattern does not correspond to the purpose of analysis from the analysis target. Thus, the flow line information for analyzing the withdrawal cause of the Web procedure can be extracted from the large amount of flow line information.

In addition, when the first pattern coincides with a part of the second pattern and a difference between the appearance frequency of the first pattern and the appearance frequency of the second pattern in the plurality of pieces of flow line information is equal to or less than the predetermined value, the flow line analysis preprocessing device according to the first embodiment excludes the first pattern. By doing this, the analysis target pattern to be outputted can be made simpler.

When the experiment data was applied to the flow line analysis preprocessing device according to the first embodiment to confirm the pattern reduction effect, the number of patterns extracted by the extraction unit could be aggregated to about 1/10. By applying an existing analysis algorithm or the like to the patterns aggregated by the preprocessing of the first embodiment, the analysis of the withdrawal cause is facilitated.

Note that, in the first embodiment, the description has been given of the case where patterns not included in the analysis target are excluded from the patterns extracted by the extraction unit 22, in the order of the unnecessary pattern exclusion unit 23, the judgement unit 24, and the overlap pattern exclusion unit 25, but this order may be replaced as appropriate.

### Second Embodiment

Next, a second embodiment will be described. Note that, in a flow line analysis preprocessing device according to the second embodiment, the same constituent components as those of the flow line analysis preprocessing device 10 according to the first embodiment are denoted by the same reference signs and detailed description thereof will be omitted. In addition, since a hardware configuration of the flow line analysis preprocessing device according to the second embodiment is the same as that of the flow line analysis preprocessing device 10 according to the first embodiment shown in FIG. 1, description thereof will be omitted.

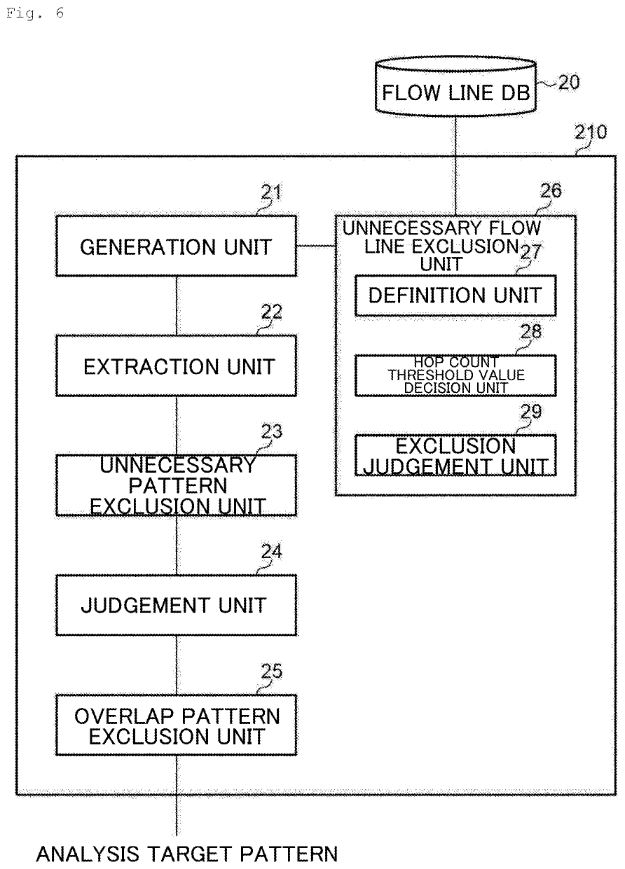

A functional configuration of the flow line analysis preprocessing device according to the second embodiment will be described. FIG. 6 is a block diagram showing an example of the functional configuration of the flow line analysis preprocessing device 210 according to the second embodiment. As shown in FIG. 6, the flow line analysis preprocessing device 210 has an unnecessary flow line exclusion unit 26, a generation unit 21, an extraction unit 22, an unnecessary pattern exclusion unit 23, a judgement unit 24, and an overlap pattern exclusion unit 25 as the functional configuration. The unnecessary flow line exclusion unit 26 further has a definition unit 27, a hop count threshold value decision unit 28, and an exclusion judgement unit 29. Each functional configuration is realized by causing the CPU 11 to read the flow line analysis preprocessing program stored in the ROM 12 or the storage 14, deploy it into the RAM 13, and execute it.

The unnecessary flow line exclusion unit 26 decides how many hops are required by the user before the Web procedure completion as an action range for the Web procedure, and excludes the flow line information of a user who does not originally intend to perform the Web procedure on the basis of the hop count. Hereinafter, the definition unit 27, the hop count threshold value decision unit 28, and the exclusion judgement unit 29 of the unnecessary flow line exclusion unit 26 will be described in detail.

The definition unit 27 defines a Web page (hereinafter referred to as “definition Web page”) which the user may pass during the Web procedure. The definition Web page is defined as a Web page which is always passed during the Web procedure. For example, in the case of a charge plan change procedure, a contract content confirmation, a charge simulation, a contract procedure change, or the like, which are shown in FIG. 1, become the definition Web pages. Specifically, the definition unit 27 receives information of the definition Web page manually designated by a flow line designer, a person in charge of analysis, or the like. In addition, the definition unit 27 may acquire the design information or the like of the flow line and extract the information of the definition Web page from the design information or the like.

Further, the definition unit 27 acquires a plurality of pieces of flow line information from the flow line DB 20, and gives a flag to a Web page corresponding to the definition Web page among Web pages included in each of the flow line information. The definition unit 27 delivers the plurality of pieces of flow line information to which the flags are given to the hop count threshold value decision unit 28.

The hop count threshold value decision unit 28 calculates a rate of the definition Web page with respect to the use range of the flow line information and a rate of the definition Web page included in the use range with respect to the total number of the definition Web pages. Then, the hop count threshold value decision unit 28 decides the number of Web pages included in the use range when both rates become maximum as the threshold value of the hop count.

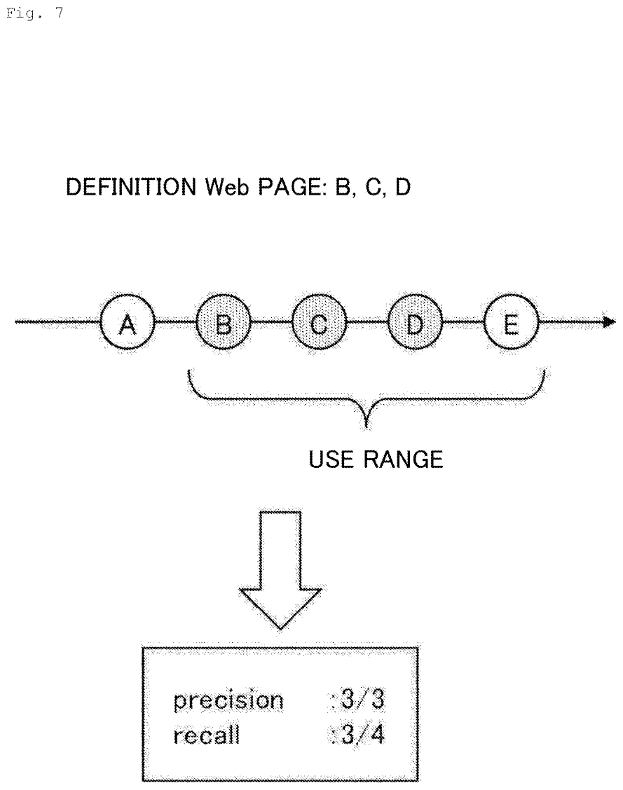

Specifically, the hop count threshold value decision unit 28 calculates an index precision indicating how much the Web page to which the flag is given can be included within the use range without missing when the use range set in the flow line information is changed. In addition, the hop count threshold value decision unit 28 calculates an index recall indicating a rate of the Web page to which the flag is given included in the use range. For example, as shown in FIG. 7, it is assumed that the definition Web pages are defined as B, C, and D, and in the flow line information indicating transitions of the Web page of A→B→C→D→E, a part of B→C→D→E is set as the use range. Note that the Web page indicated by the mesh indicates that the flag is given. In this case, it is calculated that precision=3/3 and recall=¾. In addition, the hop count threshold value decision unit 28 calculates a harmonic average F1-value of the precision and the recall.

The higher the precision and the higher the recall are, the higher the possibility that the set use range represents the action range of the Web procedure becomes. Then, the hop count threshold value decision unit 28 specifies a use range in which the harmonic average F1-value of the precision and the recall calculated for each use range set while changing is the maximum. Then, the hop count threshold value decision unit 28 decides the number of Web pages included in the use range as the threshold value of the hop count. For example, assuming that the use range shown in FIG. 7 is a use range when the F1-value becomes the maximum, the threshold value of the hop count is decided to be “4”. The hop count threshold value decision unit 28 notifies the exclusion judgement unit 29 of the decided threshold value.

Note that, in the flow line of the user who has withdrawn from the Web procedure to a store procedure, a transition to the Web page for reservation to visit the store continues after some Web pages are transited in order to perform the Web procedure. Therefore, it is considered that the flow line of the user who has withdrawn from the Web procedure to the store procedure differs from the flow line of the user who has completed the Web procedure in average length of the action. Thus, the threshold value of the hop count for deciding the action range may be separately set based on the flow line information (hereinafter referred to as “completion flow line”) for completing the Web procedure and the flow line information (hereinafter referred to as “withdrawal flow line”) for withdrawing to the store procedure. In addition, when deciding the threshold value for the withdrawal flow line, in addition to the above-described conditions, it may be considered that the definition Web page, that is, Web page to which the flag is given, is included in the same degree as the completion flow line.

Specifically, the hop count threshold value decision unit 28 calculates the precision, the recall, and the F1-value for each use range to each of the completion flow line and the withdrawal flow line. Then, the hop count threshold value decision unit 28 decides the threshold value for maximizing the F1-value as the threshold value of the completion flow line. On the other hand, as the threshold value of the withdrawal flow line, a threshold value is decided so that the recall becomes approximately the same degree as the recall of the completion flow line. This is based on the assumption that “the user who originally intends to perform the Web procedure=the user who originally intends to perform the Web procedure, but withdraws and shifts to the store procedure”.

The exclusion judgement unit 29 excludes the flow line information whose hop count is equal to or more than the threshold value by using the threshold value notified from the hop count threshold value decision unit 28. In this case, the flow line information whose hop count is equal to or more than the threshold value is regarded as the flow line information of the user who does not intend to perform the Web procedure.

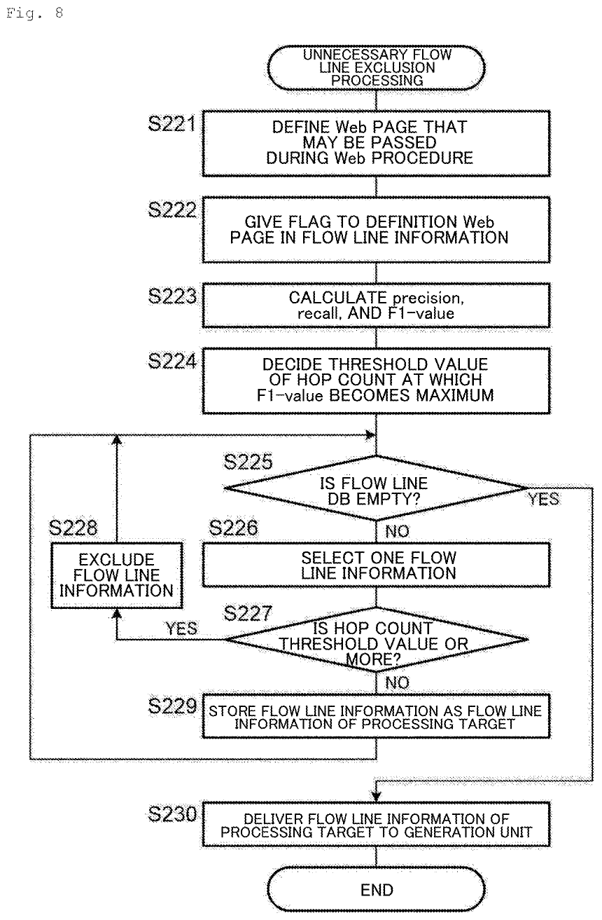

Next, operations of the flow line analysis preprocessing device 210 will be described. Also in the second embodiment, flow line analysis preprocessing shown in FIG. 5 is executed in the same manner as that in the first embodiment. However, the flow line analysis preprocessing device 210 according to the second embodiment executes unnecessary flow line exclusion processing before step S11. Here, the unnecessary flow line exclusion processing will be described with reference to FIG. 8.

In step S221, the CPU 11 defines the Web page which the user may pass during the Web procedure as the definition Web page as the definition unit 27. Next, in step S222, the CPU 11 acquires the plurality of pieces of flow line information from the flow line DB 20, gives the flag to the Web page corresponding to the definition Web page among Web pages included in each of the flow line information as the definition unit 27.

Next, in step S223, the CPU 11 calculates the index precision indicating how much the Web page to which the flag is given within the use range can be included without missing for each use range set to the flow line information as the hop count threshold value decision unit 28. In addition, the CPU 11 calculates the index recall indicating the rate of the Web page to which the flag is given included in the use range and calculates the harmonic average F1-value of the precision and the recall as the hop count threshold value decision unit 28.

Next, in step S224, the CPU 11 decides the number of Web pages included in the use range where the F1-value becomes the maximum as the threshold value of the hop count as the hop count threshold value decision unit 28. Then, in step S225, the CPU 11 decides whether or not the flow line DB 20 is empty as the exclusion judgement unit 29. When the flow line DB 20 is not empty, the processing is shifted to step S226, and the CPU 11 selects and takes out one of flow line information from the flow line DB 20 as the exclusion judgement unit 29.

Next, in step S227, the CPU 11 judges the hop count of the selected flow line information is equal to or more than the threshold value decided in above-described step S224 as the exclusion judgement unit 29. When the hop count is equal to or more than the threshold value, the processing is shifted to step S228, the CPU 11 excludes the selected flow line information as the exclusion judgement unit 29, and the processing is returned to step S225. On the other hand, when the hop count is less than the threshold value, the processing is shifted to step S229, the CPU 11 stores the selected flow line information in the set U as the flow line information to be processed as the exclusion judgement unit 29, and the processing is returned to step S225.

When it is judged that the flow line DB 20 becomes empty in step S225, the processing is shifted to step S230, and the CPU 11 delivers the flow line information stored in the set U to the generation unit 21 as the exclusion judgement unit 29, and the unnecessary flow line exclusion processing is terminated.

As described above, the flow line analysis preprocessing device according to the second embodiment regards the flow line information having the hop count equal to or more than the threshold value as the flow line information of the user who does not intend to perform the Web procedure and excludes the flow line information on the basis of the threshold value decided as the action range of the Web procedure. Thus, since the flow line information is delivered to the generation unit in a state where the flow line information unnecessary for the analysis is excluded, processing after the generation unit can be reduced.

Also, in the second embodiment, the problem that other than a series of actions for the procedure may be extracted as the pattern and the problem that the calculation amount required for pattern extraction becomes large since the individual flow line information is long can be made difficult to occur.

When the experiment data is applied to the flow line analysis preprocessing device according to the second embodiment to confirm the pattern reduction effect, it is found that the hop count of the completion flow line is approximately 30 hops or less and the hop count is approximately twice or less the hop count of the completion flow line in the withdrawal flow line. That is, by excluding the flow line information whose hop count is equal to or more than the threshold value, the flow line information unnecessary for the analysis can be excluded with high accuracy.

Note that the second embodiment has been described with respect to the case where it is judged whether to exclude all the flow line information stored in the flow line DB on the basis of the threshold value of the hop count, but this is not limited thereto. In consideration of the fact that the pattern other than the purpose is excluded by the unnecessary pattern exclusion unit, the unnecessary flow line exclusion processing of the above-described embodiment may be applied after the flow line information in which the last Web page is the Web page other than the purpose is excluded in advance.

### Third Embodiment

Next, a third embodiment will be described. Note that, in a flow line analysis preprocessing device according to the third embodiment, the same constituent components as those of the flow line analysis preprocessing device 10 according to the first embodiment are denoted by the same reference signs and detailed description thereof will be omitted. In addition, since a hardware configuration of the flow line analysis preprocessing device according to the third embodiment is the same as that of the flow line analysis preprocessing device 10 according to the first embodiment shown in FIG. 1, description thereof will be omitted.

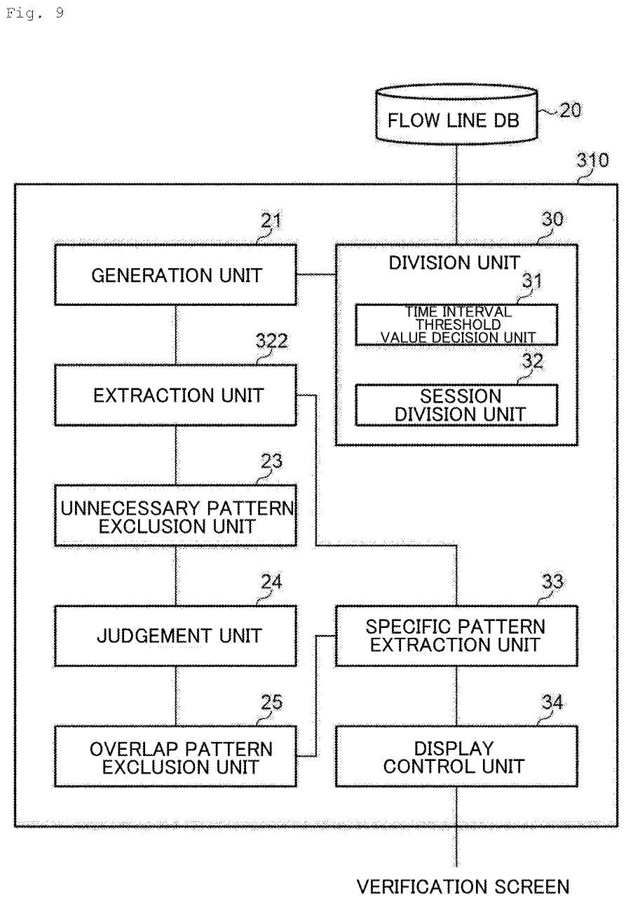

A functional configuration of the flow line analysis preprocessing device according to the third embodiment will be described. FIG. 9 is a block diagram showing an example of the functional configuration of the flow line analysis preprocessing device 310 according to the third embodiment. As shown in FIG. 9, the flow line analysis preprocessing device 310 has a division unit 30, a generation unit 21, an extraction unit 322, an unnecessary pattern exclusion unit 23, a judgement unit 24, an overlap pattern exclusion unit 25, a specific pattern extraction unit 33, and a display control unit 34 as the functional configuration. The division unit 30 further has a time interval threshold value decision unit 31 and a session division unit 32. Each functional configuration is realized by causing the CPU 11 to read the flow line analysis preprocessing program stored in the ROM 12 or the storage 14, deploy it into the RAM 13, and execute it.

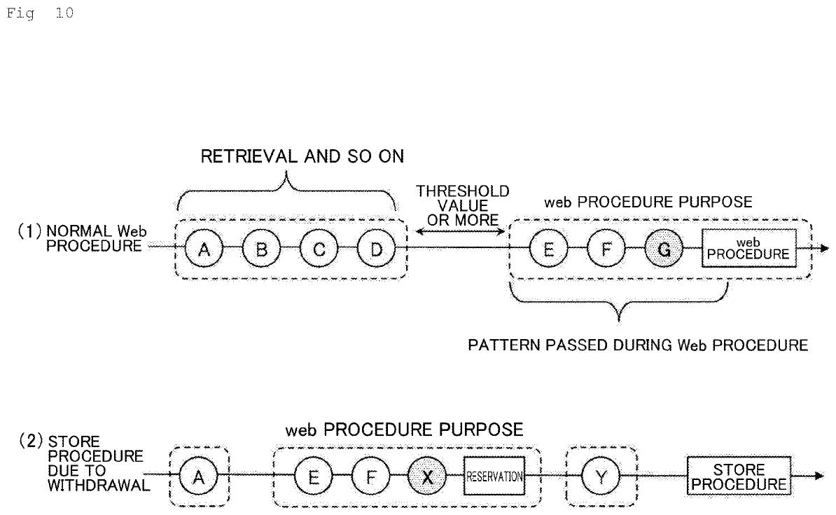

Here, a concept of the third embodiment will be described with reference to FIG. 10. In FIG. 10, a circle of A, B, . . . and the like represents the Web page. First, a series of action ranges for the procedure is decided for each user. In the third embodiment, each of the flow line information is divided for each session which is a large flow line mass in which the action of the user changes. The session is, for example, a session for searching, a session for making a contract action, a session for confirming points, etc. and the like. For example, a series of actions in which a transition time between Web pages becomes a sufficiently short predetermined time or less is regarded as one session, and when the transition time exceeds the predetermined time, it is regarded as being switched to another session.

In FIG. 10, it is assumed that a flow line (1) is a visit history of a normal Web procedure, that is, the completion flow line. The flow line (1) represents that the Web pages of A→B→C→D are sequentially visited, after an elapsed time between D and E is equal to or more than a predetermined threshold value, and the Web procedure is performed through the Web pages of E→F→G. In this case, one session is established by A→B→C→D, and one session is established by E→F→G. It is assumed that the session A→B→C→D is a session which is not directly related to the procedure such as retrieval, for example, and the Web page in the session E→F→G is a pattern of the Web page which is always passed during the Web procedure. In addition, the flow line (2) represents the case where the user originally has a plan to perform the Web procedure, but withdraws due to some causes, and select the store procedure, that is, the withdrawal flow line.

In the present embodiment, the analysis target pattern is extracted for the purpose of analyzing the withdrawal cause of the Web procedure. Therefore, the present embodiment classifies sessions that have withdrawn while intending to perform the Web procedure and gone to the store procedure from the sessions in which the flow line information has been divided. For example, in an example shown in FIG. 10, a session having a pattern partially coinciding with the pattern E→F→G included in the session divided from the flow line (1) is specified from the session divided from the flow line (2). In the example in FIG. 10, a session having a pattern common to “E→F” of E→F→G in (1) is specified. By specifying such a session, it becomes easy to grasp what action led to the withdrawal of the Web procedure, which action is different from the case where the Web procedure has been completed, by comparing the Web pages following the common E→F in (1) and (2).

Hereinafter, the description will be returned to functional configuration of the flow line analysis preprocessing device 310 according to the third embodiment.

The division unit 30 divides each of the plurality of pieces of flow line information into sessions on the basis of a time interval of transition between Web pages. Hereinafter, each of the time interval threshold value decision unit 31 and the session division unit 32 of the division unit 30 will be described in detail.

The time interval threshold value decision unit 31 decides a threshold value of a time interval of Web page transition for judging whether or not to divide the Web pages of the flow line information into sessions. Specifically, the time interval threshold value decision unit 31 fits a distribution of a logarithm of the time interval between two continuous Web pages included in each of the plurality of pieces of flow line information stored in the flow line DB 20 by a mixture Gaussian distribution of an element number 2. Then, the time interval threshold value decision unit 31 calculates such a point that a probability of being identified into class 1 and class 2 becomes equal, converts this point into the time interval, and decides it as the threshold value. The time interval threshold value decision unit 31 notifies the session division unit 32 of the threshold value of the decided time interval.

The session division unit 32 divides the flow line information for each session by separating the flow line information between the Web pages when each transition time between the Web pages included in each of flow line information is equal to or more than the threshold value decided by the time interval threshold value decision unit 31. When there is a plurality of portions where the transition time exceeds the threshold value in one piece of flow line information, one piece of flow line information is divided into three or more sessions. For example, in an example in FIG. 10, it is assumed that a session in which the transition is performed in the order of Web pages A→B→C→D and the retrieval or the like is performed is transited to another session for some purposes (in the example in FIG. 10, session of the Web procedure). The session division unit 32 delivers the divided sessions to the generation unit 21.

Similarly to the extraction unit 22 in the first embodiment, the extraction unit 322 extracts a pattern which is a set of frequent Web pages from the series data of each user delivered from the generation unit 21. Further, the extraction unit 322 extracts the completion pattern indicating transitions of the Web pages when the Web procedure is completed from a session in which the Web procedure has been performed, that is, a session obtained by dividing the completion flow line and a session in which the last Web page indicates the Web procedure completion. For example, in the example shown in FIG. 10, the extraction unit 322 extracts E→F→G as the completion pattern. The extraction unit 322 delivers the extracted completion pattern to the specific pattern extraction unit 33.

The specific pattern extraction unit 33 extracts a pattern included in a session having a partial pattern coinciding with the completion pattern delivered from the extraction unit 322 as a specific pattern.

In the present embodiment, it is considered that the withdrawal portion of the Web procedure is “a portion where typical actions change between the user who finally performs the Web procedure and the user who performs the store procedure”. Further, in the present embodiment, a series of actions for the Web procedure are started, and a pattern of the withdrawal in the middle is extracted as a specific pattern. Therefore, the specific pattern extraction unit 33 extracts the specific pattern by the following concept by using the completion pattern, that is, a typical pattern of action up to the Web procedure.

It is assumed that the number of users n (t+1, y) who have performed a partial sequence up to the t+1-th of a certain pattern P is reduced from the number of users n (t, y) who have performed a partial sequence up to the t-th among users who have performed the procedure in y (y=Web, store). In this case, the reduction number n (t, y)−n (t+1, y) corresponds to the number of cases shifted to another frequent pattern Q when y=Web is satisfied. On the other hand, when y=store is satisfied, this corresponds to any one of the following.
(i) A case where the store procedure is performed after shifting to the partial sequence of another frequent pattern Q of the Web procedure
(ii) A case for directly shifting to the action of the store procedure

When considering a probability p (t, y)=1−n (t+1, y)/n (t, y) that the user who performs the procedure at y deviates from the pattern P, when (ii) described above is small, p (t, store) and p (t, Web) are close to each other, and when (ii) is large, it is expected that different values are taken.

Specifically, the specific pattern extraction unit 33 divides the patterns outputted from the overlap pattern exclusion unit 25 into groups of patterns including a part of the completion pattern for each completion pattern such as E→F→G in FIG. 10, for example. The users who have performed the store procedure include users who do not intend to perform the Web procedure in the first place. In order to exclude such a pattern, the specific pattern extraction unit 33 extracts a pattern having the longest portion coinciding with the completion pattern as the specific pattern from patterns included in a group of the completion patterns by using the completion pattern as a role model. When there is a plurality of longest patterns, all of them may be extracted as the specific patterns, or a pattern which is later in time, that is, frequently appearing in the latter half part of the flow line information may be extracted as the specific pattern.

The display control unit 34 generates a verification screen for verifying whether or not the finally outputted analysis target pattern is correctly classified, and controls to display it on the display unit 16. For example, the display control unit 34 displays the verification screen including a list of analysis target patterns. Thus, for example, a pattern such as a visit reservation-retrieval-visit reservation can be judged to be unusable for the investigation of the withdrawal cause of the Web procedure. Note that, in the display control unit 34, a pattern selected may be manually excluded from the analysis target on the verification screen.

In addition, the display control unit 34 may include a comparison result between the completion pattern and the specific pattern extracted on the basis of the completion pattern for each group of completion patterns in the verification screen. For example, in the case of the example in FIG. 10, the completion pattern “E→F→G” and the specific pattern “E→F→X” are displayed side by side, and the different parts, the parts of G and X in this example, are displayed as high-lights, and the like. By such a display, it is easy to grasp the portion causing the withdrawal.

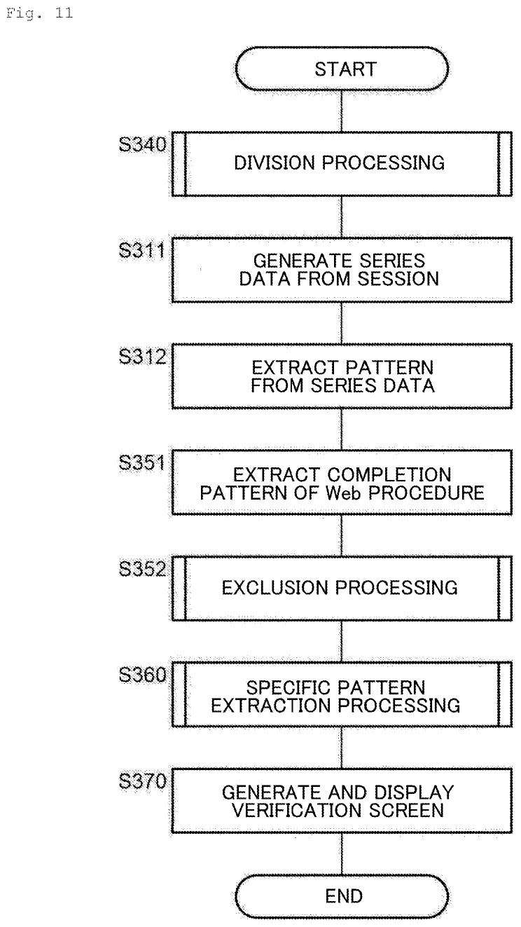

Next, operations of the flow line analysis preprocessing device 310 will be described. FIG. 11 is a flowchart showing a flow of the flow line analysis preprocessing performed by the flow line analysis preprocessing device 310. The flow line analysis preprocessing is performed by causing the CPU 11 to read the flow line analysis preprocessing program from the ROM 12 or the storage 14, deploy it into the RAM 13, and execute it. Note that the flow line analysis preprocessing is one example of the flow line analysis preprocessing method of the present disclosure.

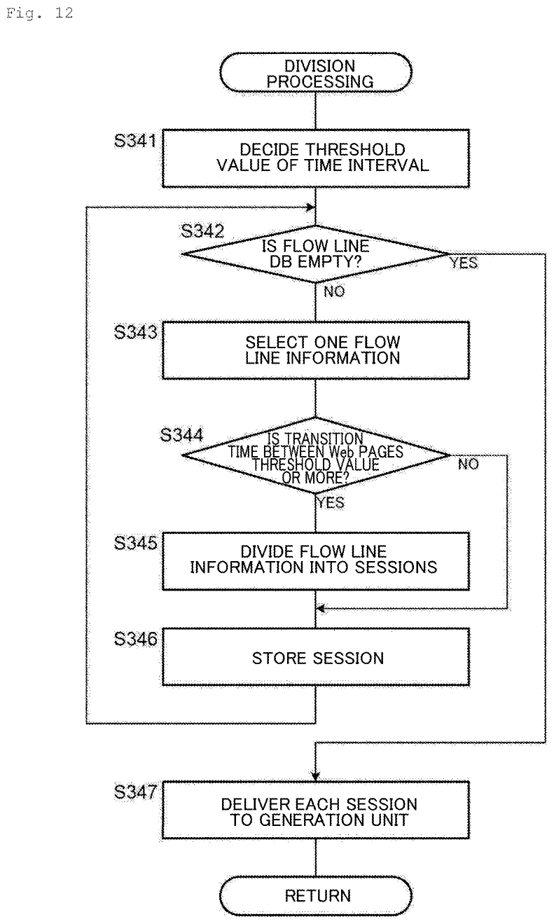

In step S340, the division processing is executed. Here, the division processing will be described with reference to FIG. 12.

In step S341, the CPU 11 decides the threshold of the time interval on the basis of the time interval between two continuous Web pages included in each of the plurality of pieces of flow line information stored in the flow line DB 20 as the time interval threshold value decision unit 31.

Then, in step S342, the CPU 11 judges whether or not the flow line DB 20 is empty as the session division unit 32. When the flow line DB 20 is not empty, the processing is shifted to step S343, and the CPU 11 selects and takes out one of flow line information from the flow line DB 20 as the session division unit 32.

Next, in step S344, the CPU 11 judges whether each transition time between Web pages included in the selected flow line information is equal to or more than the threshold value decided in above-described step S341 as the session division unit 32. When the transition time is equal to or more than the threshold value, the processing is shifted to S345, and when the transition time is less than the threshold value, the processing is shifted to step S346.

In step S345, the CPU 11 divides the flow line information for each session by separating the flow line information between Web pages whose transition time is equal to or more than the threshold value as the session division unit 32. In step S346, the CPU 11 stores the divided sessions in a set V as the session division unit 32. Note that when a negative judgement is made in step S344 and the processing is shifted to step S346, the selected flow line information is stored in the set V as it is. Then, the processing is returned to step S342.

When it is judged that the flow line DB 20 is empty in step S342, the processing is shifted to step S347, and the CPU 11 delivers each session stored in the set V to the generation unit 21 as the session division unit 32, and the division processing is terminated. Then, the processing is returned to the flow line analysis preprocessing (FIG. 11).

Next, in step S311, the CPU 11 generates series data from the session as the generation unit 21. Next, in step S312, the CPU 11 divides the series data to the series data of the session in which the Web procedure is completed and the series data of other sessions and extracts the pattern from the series data of each session as the extraction unit 322.

Next, in step S351, the CPU 11 extracts the completion pattern from the series data of the session that has performed the Web procedure and the session in which the last Web page indicates the completion of the Web procedure as the extraction unit 322.

Next, the exclusion processing is executed in step S352. The exclusion processing is the same as that of step S13 to step S20 of the flow line analysis preprocessing (FIG. 5) in the first embodiment.

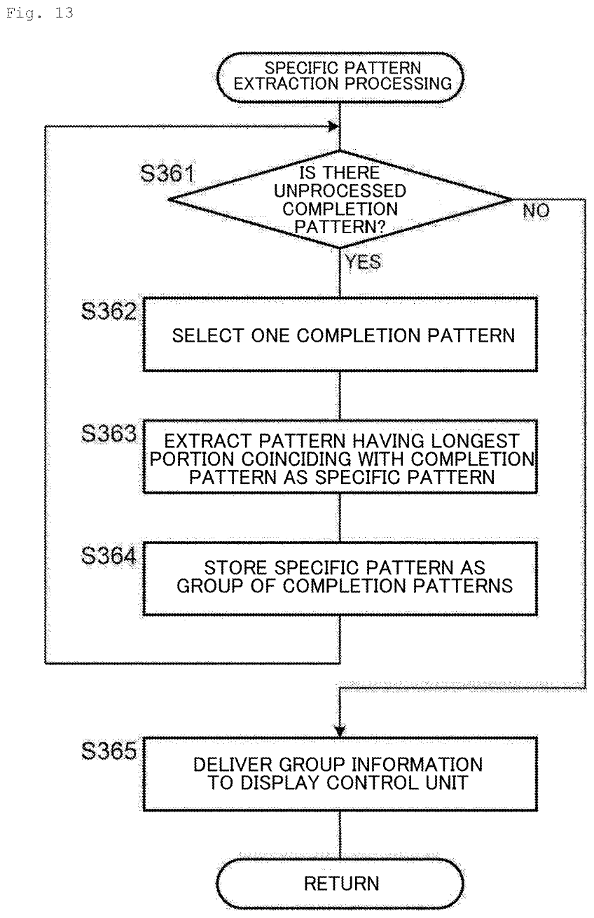

Next, the specific pattern extraction processing is executed in step S360. Here, the specific pattern extraction processing will be described with reference to FIG. 13.

In step S361, the CPU 11 judges whether or not there is a completion pattern in which subsequent processing is not yet performed among the completion patterns extracted by the extraction unit 322 as the specific pattern extraction unit 33. When there is the unprocessed completion pattern, the processing is shifted to step S362, and the CPU 11 selects one unprocessed completion pattern as the specific pattern extraction unit 33.

Next, in step S363, the CPU 11 divides a group of patterns including a part of selected completion patterns from the patterns outputted from the overlap pattern exclusion unit 25 as the specific pattern extraction unit 33. Then, the CPU 11 extracts a pattern having the longest portion coinciding with the selected completion pattern from the patterns included in the group as the specific pattern as the specific pattern extraction unit 33.

Next, in step S364, the CPU 11 stores the extracted specific pattern in the set W as a group of the selected completion patterns as the specific pattern extraction unit 33, and the processing is returned to step S361. In S361, when it is judged that all the completion patterns have been processed, the processing is shifted to step S365. In step S365, the CPU 11 delivers the group information stored in the set W, that is, the specific patterns extracted for each completion pattern to the display control unit 34 as the specific pattern extraction unit 33. Then, the specific pattern extraction processing is terminated, and the processing is returned to the flow line analysis preprocessing (FIG. 11).

Next, in step S370, the CPU 11 generates the verification screen for verifying whether or not the analysis target pattern is correctly classified and displays the verification screen on the display unit 16 as the display control unit 34. In addition, the CPU 11 excludes the pattern manually selected from the analysis target patterns from the analysis target on the verification screen as the display control unit 34. Then, the flow line analysis preprocessing is terminated.

As described above, the flow line analysis preprocessing device according to the third embodiment divides each of the plurality of flow line information into sessions on the basis of the time interval of transition between the Web pages. Then, the flow line analysis preprocessing device extracts the pattern included in the session having a partial pattern coinciding with the completion pattern indicating transitions of the Web pages when the Web procedure is completed as the specific pattern. Thus, the pattern of withdrawing the Web procedure can be accurately extracted by excluding only browsing, direct return (action of leaving the page by viewing only one page on which the user who visits the Web page first lands), or the like.

In addition, in the third embodiment, the problem that other than a series of actions for the procedure may be extracted as the pattern and the problem that the calculation amount required for pattern extraction becomes large since the individual flow line information is long can be made difficult to occur.

When the experimental data was applied to the flow line analysis preprocessing device according to the third embodiment to confirm the classification accuracy of the pattern to be excluded as the analysis target pattern and the pattern to be extracted, it was found that the patterns can be classified more accurately than those in the first embodiment and the second embodiment.

Note that the third embodiment has been described with reference to the case where the specific pattern is extracted from the pattern outputted from the overlap pattern exclusion unit 25, but the present invention is not limited thereto. The target for extracting the specific pattern may be the pattern outputted from any of the extraction unit 322, the unnecessary pattern exclusion unit 23, and the judgement unit 24.

In addition, the display control unit 34 in the third embodiment may be applied to the flow line analysis preprocessing device according to the first embodiment or the second embodiment.

Further, in the third embodiment, the specific pattern may be extracted by a method in accordance with the concept of extraction of the specific pattern using the typical pattern of the action up to the Web procedure mentioned above. Specifically, it is assumed that the number of users who have performed the partial sequence up to the t+1-th of a certain pattern P is defined as n (t+1, y) and the number of users who have performed the partial sequence up to the t-th is defined as n (t, y) among users who have performed the procedure in y (y=Web, store). Then, a probability p (t, y)=1−n (t+1, y)/n (t, y) that the user who performs the procedure at y deviates from the pattern P is calculated and a pattern p in which a difference between p (t, store) and p (t, Web) is equal to or more than a predetermined value is extracted as the specific pattern.

Further, in each of the above-described embodiments, as one example of the transition of the action or the state for each user, a case where the flow line information indicating the transition of the Web pages for each user is defined as the analysis target, but the present invention is not limited thereto. For example, flow line information indicating a movement locus of a user in a facility or the like may be used as the target. In this case, for example, in the movement locus indicated by the flow line information, a portion passing through a predetermined point in the facility may be extracted as a pattern which is a set of actions or states.

Note that in each of the above-described embodiments, various types of processors other than the CPU may execute the flow line analysis preprocessing executed by the CPU reading the software (program). In this case, examples of the processor include a PLD (Programmable Logic Device) whose circuit configuration can be changed after manufacturing, such as an FPGA (Field-Programmable Gate Array) and a dedicated electric circuit that is a processor having a circuit configuration designed as a dedicated configuration to execute specific processing, such as an ASIC (Application Specific Integrated Circuit). Also, the flow line analysis preprocessing may be performed by one of these various processors, or may be executed by a combination of two or more processors of the same type or different types (for example, a plurality of FPGAs, a combination of the CPU and the FPGA, or the like). Further, more specifically, a hardware configuration of these various processors is an electric circuit in which circuit elements such as semiconductor elements are combined.

In addition, in each of the above-described embodiment, an aspect has been described in which the flow line analysis preprocessing program is previously stored (installed) in the ROM 12 or the storage 14. However, the present invention is not limited to this. The program may be provided in a form in which the program is stored in a non-transitory storage medium such as a CD-ROM (Compact Disk Read Only Memory), a DVD-ROM (Digital Versatile Disk Read Only Memory), or a USB (Universal Serial Bus) memory. In addition, the program may be downloaded from an external device via a network.

Regarding the above embodiments, the following supplements are further disclosed.

### (Supplement Item 1)

A flow line analysis preprocessing device including:
a memory; and
at least one processor connected to the memory, wherein the processor is configured to
extract a pattern that is a set of frequent Web pages from a plurality of pieces of flow line information indicating transitions of Web pages for each user,
judge a pattern having an appearance frequency in the plurality of pieces of flow line information equal to or more than a threshold value for each of the extracted patterns as an analysis target pattern, and
exclude a pattern in which the last Web page of the pattern does not correspond to a purpose of analysis from the analysis target pattern.

### (Supplement Item 2)

A non-transitory recording medium storing a program executable by a computer to execute flow line analysis preprocessing, wherein
the flow line analysis preprocessing includes
extracting a pattern that is a set of frequent Web pages from a plurality of pieces of flow line information indicating transitions of Web pages for each user,
judging a pattern having an appearance frequency in the plurality of pieces of flow line information equal to or more than a threshold value as an analysis target pattern for each of the extracted patterns, and
excluding a pattern in which the last Web page of the pattern does not correspond to a purpose of analysis from the analysis target pattern.

[Reference Signs List]

| | |
|---|---|
| 10, 210, 310 | Flow line analysis preprocessing device |
| 11 | CPU |
| 12 | ROM |
| 13 | RAM |
| 14 | Storage |
| 15 | Input unit |
| 16 | Display unit |
| 17 | Communication I/F |
| 19 | Bus |
| 20 | Flow line DB |
| 21 | Generation unit |
| 22, 322 | Extraction unit |
| 23 | Unnecessary pattern exclusion unit |
| 24 | Judgement unit |
| 25 | Overlap pattern exclusion unit |
| 26 | Unnecessary flow line exclusion unit |
| 27 | Definition unit |
| 28 | Hop count threshold value decision unit |
| 29 | Exclusion judgement unit |
| 30 | Division unit |
| 31 | Time interval threshold value decision unit |
| 32 | Session division unit |
| 33 | Specific pattern extraction unit |
| 34 | Display control unit |

1. A flow line analysis preprocessing device configured to:
extract a pattern that is a set of frequent actions or states from a plurality of pieces of flow line information indicating transitions of actions or states for each user;
judge a pattern having an appearance frequency in the plurality of pieces of flow line information equal to or more than a threshold value for each of the patterns extracted by the extraction unit as an analysis target pattern; and
exclude a pattern in which the last action or state of the pattern does not correspond to a purpose of analysis from the analysis target pattern.

2. The flow line analysis preprocessing device according to claim 1, further configured to:
exclude one of two patterns partially coinciding with each other among the patterns extracted.

3. The flow line analysis preprocessing device according to claim 2, further configured to:
excludes a first pattern when the first pattern coincides with a part of a second pattern and a difference between the appearance frequency of the first pattern and the appearance frequency of the second pattern in the plurality of pieces of flow line information is equal to or less than a predetermined value.

4. The flow line analysis preprocessing device according to claim 1, further configured to:
exclude flow line information including transitions of actions and states equal to or more than a hop count required for reaching a specific action or state, which is decided on the basis of a rate of definition actions and states defined as an action or state passing for reaching the specific action or state with respect to a use range of the flow line information and a rate of the definition actions and states included in the use range with respect to a total number of the definition actions and states for each of the plurality of pieces of flow line information.

5. The flow line analysis preprocessing device according to claim 1, further configured to:
divide each of the plurality of pieces of flow line information into sessions on the basis of a time interval of transition between actions or states; and
extract a pattern included in a session having a partial pattern coinciding with a completion pattern indicating transitions of actions or states when reaching a specific action or state as a specific pattern, wherein
the completion pattern is extracted from a session that has reached the specific action or state.

6. The flow line analysis preprocessing device according to claim 5, further comprising:
a display controller configured to perform a display in which the completion pattern and the specific pattern are compared.

7. A flow line analysis preprocessing method comprising:
extracting, a pattern that is a set of frequent actions or states from a plurality of pieces of flow line information indicating transitions of actions or states for each user;
judging a pattern having an appearance frequency in the plurality of pieces of flow line information equal to or more than a threshold value for each of the patterns extracted as an analysis target pattern; and
excluding a pattern in which the last action or state of the pattern does not correspond to a purpose of analysis from the analysis target pattern.

8. (canceled)

9. The flow line analysis preprocessing method according to claim 7, comprising:
excluding one of two patterns partially coinciding with each other among the patterns extracted.

10. The flow line analysis preprocessing method according to claim 9, comprising:
excluding a first pattern when the first pattern coincides with a part of a second pattern and a difference between the appearance frequency of the first pattern and the appearance frequency of the second pattern in the plurality of pieces of flow line information is equal to or less than a predetermined value.

11. The flow line analysis preprocessing method according to claim 7, comprising:
excluding flow line information including transitions of actions and states equal to or more than a hop count required for reaching a specific action or state, which is decided on the basis of a rate of definition actions and states defined as an action or state passing for reaching the specific action or state with respect to a use range of the flow line information and a rate of the definition actions and states included in the use range with respect to a total number of the definition actions and states for each of the plurality of pieces of flow line information.

12. The flow line analysis preprocessing method according to claim 7, comprising:
dividing each of the plurality of pieces of flow line information into sessions on the basis of a time interval of transition between actions or states; and
extracting a pattern included in a session having a partial pattern coinciding with a completion pattern indicating transitions of actions or states when reaching a specific action or state as a specific pattern, wherein
the completion pattern from a session that has reached the specific action or state.

13. The flow line analysis preprocessing method according to claim 12, comprising:
a display controller configured to perform a display in which the completion pattern and the specific pattern are compared.

14. A computer-readable non-transitory recording medium storing computer-executable program instructions that when executed by a processor cause a computer to execute a flow line analysis preprocessing method comprising:
extracting a pattern that is a set of frequent actions or states from a plurality of pieces of flow line information indicating transitions of actions or states for each user;
judging a pattern having an appearance frequency in the plurality of pieces of flow line information equal to or more than a threshold value for each of the patterns extracted as an analysis target pattern; and
excluding a pattern in which the last action or state of the pattern does not correspond to a purpose of analysis from the analysis target pattern.

15. The computer-readable non-transitory recording medium according to claim 14, comprising:
excluding one of two patterns partially coinciding with each other among the patterns extracted.

16. The computer-readable non-transitory recording medium according to claim 15, comprising:
excluding a first pattern when the first pattern coincides with a part of a second pattern and a difference between the appearance frequency of the first pattern and the appearance frequency of the second pattern in the plurality of pieces of flow line information is equal to or less than a predetermined value.

17. The computer-readable non-transitory recording medium according to claim 15, comprising:
excluding flow line information including transitions of actions and states equal to or more than a hop count required for reaching a specific action or state, which is decided on the basis of a rate of definition actions and states defined as an action or state passing for reaching the specific action or state with respect to a use range of the flow line information and a rate of the definition actions and states included in the use range with respect to a total number of the definition actions and states for each of the plurality of pieces of flow line information.

18. The computer-readable non-transitory recording medium according to claim 14, comprising:
dividing each of the plurality of pieces of flow line information into sessions on the basis of a time interval of transition between actions or states; and
extracting a pattern included in a session having a partial pattern coinciding with a completion pattern indicating transitions of actions or states when reaching a specific action or state as a specific pattern, wherein
the completion pattern from a session that has reached the specific action or state.

19. The computer-readable non-transitory recording medium according to claim 18, comprising:
a display controller configured to perform a display in which the completion pattern and the specific pattern are compared.
